(19) United States
(12) Patent Application Publication
(10) Pub. No.: US 2011/0295687 A1
(43) Pub. Date: Dec. 1, 2011

(54) Per-User Predictive Profiles for Personalized Advertising

(75) Inventors: Mikhail Bilenko, Redmond, WA (US); Matthew Richardson, Seattle, WA (US)

(73) Assignee: MICROSOFT CORPORATION, Redmond, WA (US)

(21) Appl. No.: 12/787,410

(22) Filed: May 26, 2010

(51) Int. Cl. G06Q 30/00; G06F 17/30; G06F 7/00; G06Q 10/00; G06F 15/18

(52) U.S. Cl. 705/14.54; 705/14.66; 706/12; 707/706; 707/734; 707/E17.014

(57) ABSTRACT

Described is using per-user profile data (e.g., maintained in a browser cookie) as a factor in selecting advertisements to be presented to a user for a current context such as containing query keywords. For example, an advertiser may be willing to bid more if the current context's keywords match the user profile data that indicates a particular area of interest to the user and advertiser. Also described is updating the per-user profile data with the current context if doing so increases the expected utility of the per-user profile data, e.g., increases the predicted amount of revenue from advertisement clicking. Also described is other advertisement personalization based upon the per-user profile data, e.g., the ranking and/or appearance of the advertisements.

### BACKGROUND

Online advertising is a significant revenue source for providers of Web content and applications. In general, advertisers pay when an advertisement is clicked, and thus it is desirable when relevant advertisements are shown. Targeting mechanisms for finding relevant advertisements are generally based on matching the advertisements to delivery context, such as keywords extracted from a current search query or webpage, or keywords found through various semantic associations

To further increase the relevance of advertisements, advertising personalization, traditionally referred to as behavioral targeting, has been attempted in various ways. Current behavioral targeting is generally based upon demographic data and membership in predefined segments (e.g., “Gaming Enthusiasts”).

While behavioral targeting thus provides some improvement, current behavioral targeting operates at a relatively coarse granularity, in that many users are clustered together into the same profile. As a result, many of the advertisements that are shown are still irrelevant to many users. Any improvement in providing more relevant advertisements is beneficial to users, advertisers and web content/application providers.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards a technology by which per-user profile data is maintained and used as a factor in selecting content (e.g., advertisements) based upon a current context and/or user interaction with one or more of the advertisements. In this way, the selected content may be personalized for each user.

In one implementation, the per-user profile data is maintained at the client-side, such as in a browser cookie. When a content provider (e.g. an advertising platform) receives the per-user profile data and the current context information, the advertising platform may select the advertisements based upon the current context information and the per-user profile data, as well as advertiser bid data. For example, an advertiser may be willing to bid more (or less) to have an advertisement shown when the keywords in the current context correspond to keywords in the user profile data that indicate a particular area of interest to the user and advertiser.

Content may be personalized in other ways based upon the per-user profile data, such as to rank advertisements relative to one another based upon the per-user profile data. Similarly, other personalization may be performed, such as to change the presentation (e.g., color, size, audio and/or other concepts) of at least one of the advertisements based upon the per-user profile data.

The content provider may update the per-user profile data based upon the current context, such as if the update increases the expected utility of the profile data. For example, machine learning can determine parameters that are used in determining whether data in the current context will increase the utility of the profile data if added to the profile data.

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 is a block diagram representing selection of a personalized advertisement based upon a current context and a current profile for a user.

FIG. 2 is a block diagram representing example components by which a user profile is constructed offline and updated online.

FIG. 3 is a flow diagram representing example steps for providing personalized advertisements and updating a client profile.

FIG. 4 shows an illustrative example of a computing environment into which various aspects of the present invention may be incorporated.

### DETAILED DESCRIPTION

Various aspects of the technology described herein are generally directed towards constructing and updating user profiles that are stored per client (e.g., on the client/user side) and used in the selection and/or presentation of advertisements. In one implementation, such profiles are concise, as well as human-readable and user editable such that users have direct control over their profiles and are able to enhance and modify them, e.g., by modifying, adding or removing data.

As a result of having per-user profile data, more relevant advertisements (as well as possibly other content) may be provided to each specific user. Moreover, having profiles stored on the client side avoids privacy issues that may arise when storing profile data on the server side (the advertising platform).

It should be understood that any of the examples herein are non-limiting. As one example, while selecting relevant advertisements is one use of user profiles, other usages are feasible, including personalizing search results for a user, whether for an internet or intranet search. As another example, personalized recommendations may be provided, e.g., product recommendations on a shopping site. As such, the present invention is not limited to any particular embodiments, aspects, concepts, structures, functionalities or examples described herein. Rather, any of the embodiments, aspects, concepts, structures, functionalities or examples described herein are non-limiting, and the present invention may be used in various ways that provide benefits and advantages in computing and search technology in general.

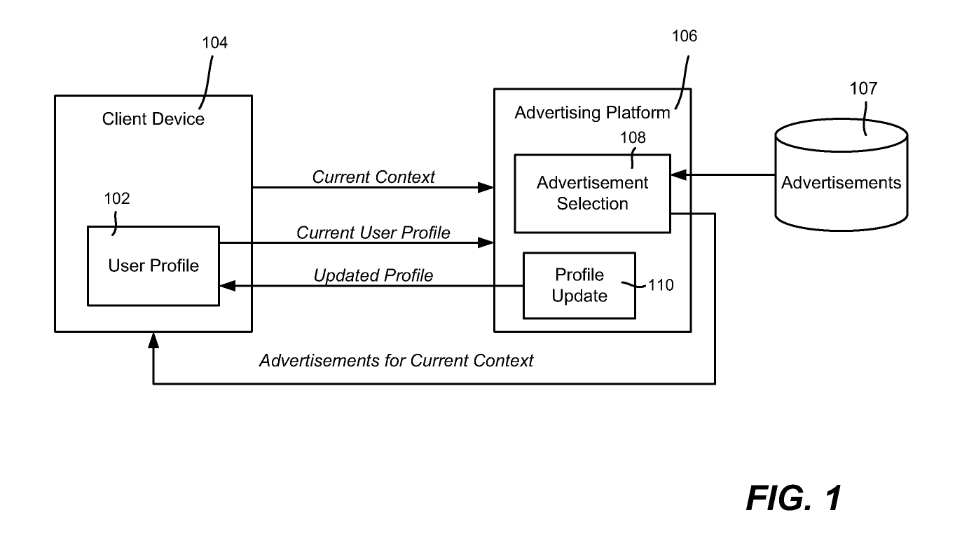

FIG. 1 is a block diagram showing a system including a user profile 102 maintained at a client device 104 for use in personalization/behavioral targeting, such as by an advertising platform 106 that serves advertisements 107. While one example client device 104 with a single user profile 102 is shown, it is understood that many such client devices, some with more than one user profile, are likely to be present in an online production system. Note that the same user may have more than one profile as well, e.g., one on a work computer and one on a home computer.

Each user profile (e.g., 102) is constructed so as to generally summarize the interests and/or preferences of the user (historical and/or predicted) for subsequent use by the advertising platform 106 in advertisement selection 108. In one implementation, user profiles are data structures generally comprised of components (e.g., terms such as keywords, categories, product names) and/or associated information (e.g., weights, frequencies, last-used-dates, categories or other labels). For example, the profile data may record a number of search occurrences per user:

Uᵢ={occᵢ₁,occᵢ₂, . . . },where occᵢⱼ=<keyword, time, type, match>.

Keyword represents the query or advertising keyword, time is the time the event occurred, type may be “search”, “ad”, or “adclick” (ad means an advertisement for the given keyword was shown to the user, but the user did not click), and match may be “exact”, “broad”, or “phrase”, depending on the match type between the query and advertising keyword. Such data may be processed to determine which data to keep in the user profile 102 (constructed and compacted) based on user behavior history, e.g., by using machine learning methods that optimize expected utility of the profile for the purpose of serving relevant advertisements to the user, as described below.

In one implementation, the user profile 102 is maintained in a browser cookie. However, as can be readily appreciated, other data structures are suitable, e.g., a client device may have its own application that retrieves advertisements, and that application may maintain the user profile's data as suitable for its purposes.

While there is no absolute size limitation on the amount of profile data that may be maintained for a given user, there may be practical limitations, e.g., based on client storage, network traffic and so forth. For example, in an implementation that uses a browser cookie, a practical limit (e.g., 1 KB to 4 KB) may be present, and thus a compact user profile is desirable. Compaction may be achieved by selecting a limited set of components to maintain for the user, e.g., those that maximize utility as described below.

As represented in FIG. 1, information from the client device 104 about the current context (e.g., the search query during search advertising) is received at the advertising platform 106. Note that the advertising platform 106 may be incorporated into or associated with a search engine or the like, and thus the communication from the client device 104 may not be directly to the advertising platform, but rather coupled through one or more intermediary entities. The advertising platform 106 also receives the user profile 102, and may use the context and the profile data to select one or more advertisements, e.g., as represented by the advertisement selection 108. These advertisements, which may be personalized via the user profile 102, are then sent to the client device 104, e.g., on a search results page via a search engine query response.

With respect to the advertisements selected according to the user profile (as well as other information such as time-of-day, or day-of-week that may be considered), an advertiser may choose to show advertisements only for certain users, based on their past or expected future behavior. By modeling each user's interests, the advertising platform 106 may select additional advertisements over those selected based on just the context (e.g., the current query or web page context).

By way of example, an advertiser may bid more to show an advertisement if one (or more) of the per-user profile data's keywords match (not necessarily exactly) the current context's keywords for which the advertiser is otherwise interested in showing advertisements. Thus, advertiser bid data, the current context's keywords and the per-user profile data's keywords are used as a basis for advertisement selection.

Further, the presentation of the advertisements may be personalized. For example, certain advertisements may be ranked relatively higher in appearance order when they are deemed related to the use's interests. The actual appearance of the advertisement may be modified by the advertising platform 106, (possibly as specified by the advertiser), e.g., to match preferences of certain users by having different color schemes or visual layouts based upon different user demographics. Similarly, the text of an advertisement may be altered to better suit the likely interests of the user. The advertisement platform also may suppress an advertisement based on the user profile, e.g., to not to show any advertisements at all, or to show fewer advertisements than otherwise. Also, as described below, the advertising platform 106 may charge advertisers more for clicks from users who are more likely to make a purchase based on their user profile data.

As further shown in FIG. 1, the advertising platform may update the user profile, as represented by the profile update mechanism 110, and send the updated profile data to the client device 104. In one implementation, a deployed client-side profile is updated by the advertising platform 106 based only on the previous (current until updated) profile data and the immediate context of the current session, which may include various information including (but not limited to) search queries and browsing events. Note that the profile update may also be done asynchronously, e.g., a profile may be only updated after several advertisement requests have been served. Thus, for example, the profile data may maintain additional information beyond the components (such as the query terms, time data and so forth) that is later used for updating.

Note that in one implementation, some of the information may be maintained for a user on the server side or elsewhere. For example, private information may be maintained on the client side, however generic information (as is done today) may be maintained on the server, and mixed in an appropriate way with the client-side profile data. A user may choose a privacy level for example, that balances the information maintained on the client versus that maintained on the server. Also, some or all of the user profile data may be cached online rather than physically on the client device.

As mentioned above, the user may be able to edit his or her profile, to add, remove or modify information, such as terms, categories and product names. If the information is maintained in text (or decrypted from encrypted text that helps maintain privacy when communicating the information), any text editor may suffice, however a more specific editing application may be used. For example, computed or other information such as weights, frequencies, last-used-dates, categories or other labels may not be directly edited, or may be editable only within certain limits (e.g., a user can only increase or decrease a weight within an allowed range).

As can be readily appreciated, there is a significant amount of information that is available for a typical user, however only some of it is of interest to an advertising platform. For example, a user may have a few areas of interest, with only a rare deviation from those areas. In general, it is desirable to construct and maintain a compact profile that may be efficiently accessed and processed by the advertising platform in a way that allows the relevant information about the user to be easily extracted. A function of the profile update mechanism 110 is thus to determine whether or not to add components (and thus potentially remove other components) based upon the current context. As described below, this may be based on an estimation of the utility of adding the components (or not adding them).

While any mechanism may be used to determine whether and how to update a user profile given a current context, such as a simple rule-based mechanism, one more sophisticated algorithm for constructing such a profile operates to maximize an objective function (find the parameters) so as to maximize the value of the profiles to the overall utility used in the advertising platform. A general goal is to include information in the profile corresponding to a search/query that the user will likely submit again, and then click on an advertisement after such a search.

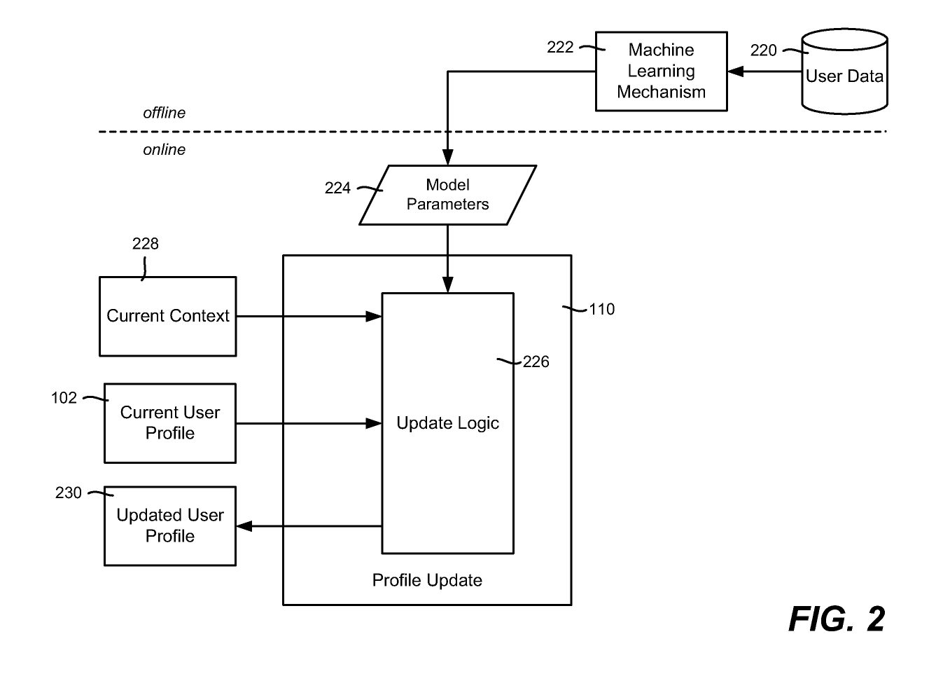

FIG. 2 represents such a machine learning type of updating mechanism. User data 220 such as collected in query logs and the like is processed by a machine learning mechanism 222 to learn model parameters 224, such as the relative weights and various other parameters used to determine the various components in each entry of the current user profile. As generally described below, update logic 226 in the profile update mechanism 110 determines whether the current user profile 102 will be positively changed with respect to its predicted utility according to the current context 228. If so, then the current user profile is updated based on the current context, and the updated user profile 230 returned to the client device. If not, the current user profile remains unchanged.

The utility measurement may depend on the specific monetization model utilized by the advertising platform. One example of such a model is bid increments, in which advertisers specify an increase in the amount they pay to the platform when their advertisement is clicked by a user whose profile indicates that the advertisement is specifically relevant to that user. Bid increments may be used with various monetization mechanisms, such as CPC (cost-per-click) or CPM (cost-per-impression).

Optimal profile construction is basically equivalent to considering the possible profiles for a given user, estimating a utility score for each one, and choosing the profile that has maximum expected utility. In the context of bid increment personalized advertising, the utility of the profile may be measured by the total amount of additional revenue that it contributes. The overall contribution of the profile can be decomposed via the contributions of individual keywords; (note however that if multiple keywords result in a bid increment, the increment is only charged once, as described below with reference to the set of profile components having the submodular property). The task of constructing a maximum-utility profile is then basically equivalent to computing the expected utility of each potential profile component (e.g., keyword), and selecting the set of components that results in maximum overall utility. However, this is computationally expensive, and instead a profile that is reasonably good yet efficiently found is selected, as described herein.

In this model, a bid increment is charged only once, even if multiple profile components trigger the bid increment. Thus, the overall profile utility is a submodular function: informally, the utility of adding a keyword to a profile is less or equal to the utility of the keyword itself. For example, adding “cat” to a profile that already includes “dog” may lower the utility because the addition will not change the profile much (either will trigger the same advertisement) yet will remove another keyword that will no longer be available for a bid increment. Thus, the profile construction problem may be solved as an instance of submodular minimization problem, (which is NP-hard, but for which efficient

$$( 1 - \frac{1}{e} )$$

—approximation algorithms exist). The profile construction problem comprises the task of identifying a maximal-utility set K={k₁ . . . kₙ} of at most n components out of P relevant components associated with the user:

Profile(User)=argmax_{K:|K|<n,K⊂P}Utility(K)

Actual component utility is dependent on the specific monetization mechanism. For a bid increment setting implementation, it is equivalent to the revenue difference attributed to the bid increments that were triggered by the profiles times the (estimated) number of times a user will click on an advertisement that had the resulting bid increment. For any individual component (e.g., keyword), the utility can be computed by machine learning methods, which utilize historical data from users (which may be groups of similar users rather than all users) to perform estimation of expected revenue from a given keyword. There are a number of specific learning method implementations that are available, which can approximate the computation of expected bid increment revenue in various ways.

A particular decomposition can approximate bid increment revenue by estimating the expected number of clicks on ads for the keyword for the user via a parametric model (such as decision tree ensembles or neural networks), where the parameters θ are learned based on historical data about users clicking on advertisements for particular keywords:

$$\begin{matrix}Utility ( k ) ≃ E [ Clicks ( k ) ] \times BidIncrement ( k ) \\ ≃ {MLClicks}_{θ} ( k ) \times BidIncrement ( k )\end{matrix}$$

Given the sparsity of click events, an approximation of the expected number of clicks may be based on estimating the expected number of searches related to the keyword, multiplied by the predicted clickthrough rate for those searches for the user:

Utility(k)≃MLSearches_{θ}(k)×E[CTR(k)]×BidIncrement(k)

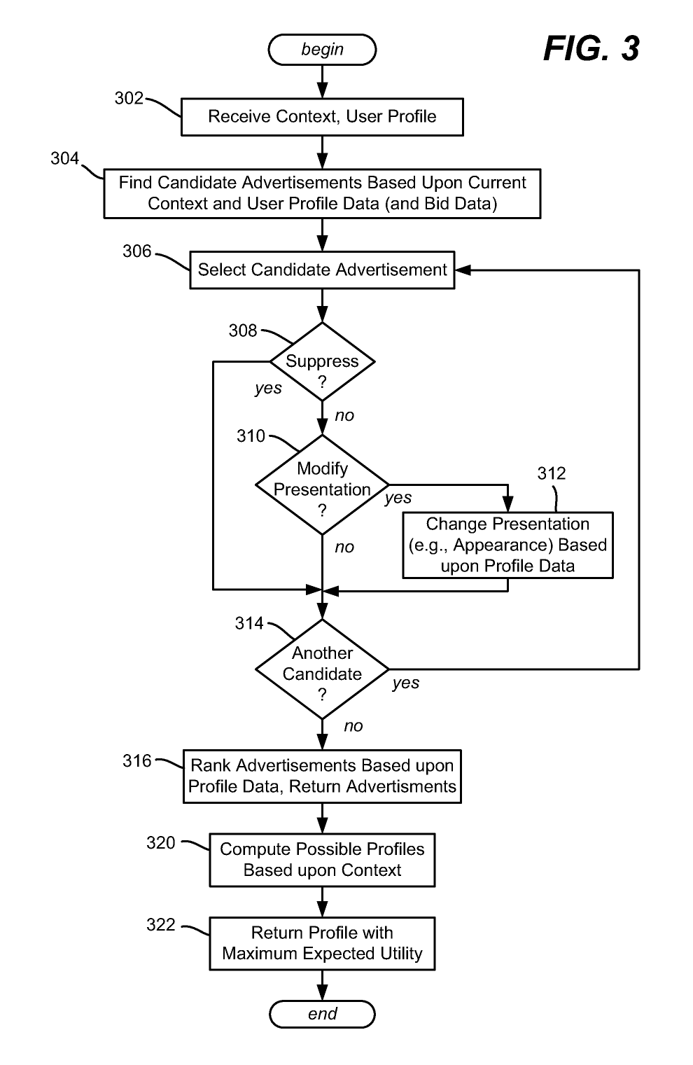

By way of a summary, FIG. 3 is a flow diagram exemplifying some of the various aspects described herein as example steps that may be present in a given implementation. Step 302 represents receiving the context and user profile at the advertisement platform or the like. Step 304 selects a set of candidate advertisements based on the current context and user profile data. Note that this may be based upon a combination of context keyword matching as well as user profile keyword matching, as well as bid increment considerations. In general, the advertiser wants to know whether this context corresponds to a known area of interest to the user, and if so, is willing to pay more to have its advertisement selected.

Step 306 represents processing the candidate advertisements, which in this example is shown by selecting one at a time, however advertisements may be selected and/or processed in parallel. Step 308 determines whether the selected candidate advertisement is to be suppressed for any reason, such as if it may be offensive to that particular user as known from the profile data. Note that suppression may be built into step 304, e.g., only non-suppressed advertisements may be initially selected.

Step 310 represents evaluating whether the advertisement is to have its presentation such as its appearance modified and/or configured in any way based upon the profile data, including any changes to highlighting, coloring, flashing and/or movement and the like, as well as changes to text and/or images, and/or audio, animation and so forth turned on or off. If so, step 312 represents making the changes.

Step 314 repeats for other candidates, until zero or more advertisements remain. These may be ranked relative to one another at step 316, and (if any remain) are returned to the requesting entity, e.g., a search engine that will place one or more of them in a search results page.

Steps 320 and 322 represents the profile updating operations based upon the current context. As described above, the various profiles may be computed (step 322) and the profile with the maximum expected utility is returned (although if unchanged the user profile need not be returned).

### Exemplary Operating Environment

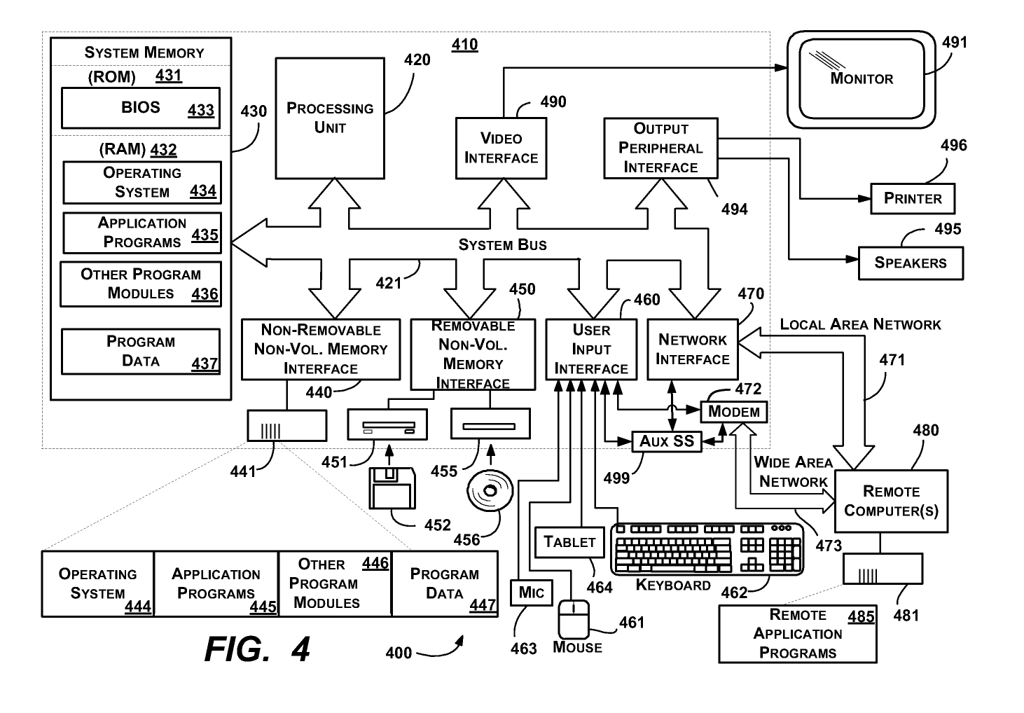

FIG. 4 illustrates an example of a suitable computing and networking environment 400 on which the examples of FIGS. 1-3 may be implemented. The computing system environment 400 is only one example of a suitable computing environment and is not intended to suggest any limitation as to the scope of use or functionality of the invention. Neither should the computing environment 400 be interpreted as having any dependency or requirement relating to any one or combination of components illustrated in the exemplary operating environment 400.

The invention is operational with numerous other general purpose or special purpose computing system environments or configurations. Examples of well-known computing systems, environments, and/or configurations that may be suitable for use with the invention include, but are not limited to: personal computers, server computers, hand-held or laptop devices, tablet devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 4, an exemplary system for implementing various aspects of the invention may include a general purpose computing device in the form of a computer 410. Components of the computer 410 may include, but are not limited to, a processing unit 420, a system memory 430, and a system bus 421 that couples various system components including the system memory to the processing unit 420. The system bus 421 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 410 typically includes a variety of computer-readable media. Computer-readable media can be any available media that can be accessed by the computer 410 and includes both volatile and nonvolatile media, and removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer 410. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above may also be included within the scope of computer-readable media.

The system memory 430 includes computer storage media in the form of volatile and/or nonvolatile memory such as read only memory (ROM) 431 and random access memory (RAM) 432. A basic input/output system 433 (BIOS), containing the basic routines that help to transfer information between elements within computer 410, such as during start-up, is typically stored in ROM 431. RAM 432 typically contains data and/or program modules that are immediately accessible to and/or presently being operated on by processing unit 420. By way of example, and not limitation, FIG. 4 illustrates operating system 434, application programs 435, other program modules 436 and program data 437.

The computer 410 may also include other removable/non-removable, volatile/nonvolatile computer storage media. By way of example only, FIG. 4 illustrates a hard disk drive 441 that reads from or writes to non-removable, nonvolatile magnetic media, a magnetic disk drive 451 that reads from or writes to a removable, nonvolatile magnetic disk 452, and an optical disk drive 455 that reads from or writes to a removable, nonvolatile optical disk 456 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 441 is typically connected to the system bus 421 through a non-removable memory interface such as interface 440, and magnetic disk drive 451 and optical disk drive 455 are typically connected to the system bus 421 by a removable memory interface, such as interface 450.

The drives and their associated computer storage media, described above and illustrated in FIG. 4, provide storage of computer-readable instructions, data structures, program modules and other data for the computer 410. In FIG. 4, for example, hard disk drive 441 is illustrated as storing operating system 444, application programs 445, other program modules 446 and program data 447. Note that these components can either be the same as or different from operating system 434, application programs 435, other program modules 436, and program data 437. Operating system 444, application programs 445, other program modules 446, and program data 447 are given different numbers herein to illustrate that, at a minimum, they are different copies. A user may enter commands and information into the computer 410 through input devices such as a tablet, or electronic digitizer, 464, a microphone 463, a keyboard 462 and pointing device 461, commonly referred to as mouse, trackball or touch pad. Other input devices not shown in FIG. 4 may include a joystick, game pad, satellite dish, scanner, or the like. These and other input devices are often connected to the processing unit 420 through a user input interface 460 that is coupled to the system bus, but may be connected by other interface and bus structures, such as a parallel port, game port or a universal serial bus (USB). A monitor 491 or other type of display device is also connected to the system bus 421 via an interface, such as a video interface 490. The monitor 491 may also be integrated with a touch-screen panel or the like. Note that the monitor and/or touch screen panel can be physically coupled to a housing in which the computing device 410 is incorporated, such as in a tablet-type personal computer. In addition, computers such as the computing device 410 may also include other peripheral output devices such as speakers 495 and printer 496, which may be connected through an output peripheral interface 494 or the like.

The computer 410 may operate in a networked environment using logical connections to one or more remote computers, such as a remote computer 480. The remote computer 480 may be a personal computer, a server, a router, a network PC, a peer device or other common network node, and typically includes many or all of the elements described above relative to the computer 410, although only a memory storage device 481 has been illustrated in FIG. 4. The logical connections depicted in FIG. 4 include one or more local area networks (LAN) 471 and one or more wide area networks (WAN) 473, but may also include other networks. Such networking environments are commonplace in offices, enterprise-wide computer networks, intranets and the Internet.

When used in a LAN networking environment, the computer 410 is connected to the LAN 471 through a network interface or adapter 470. When used in a WAN networking environment, the computer 410 typically includes a modem 472 or other means for establishing communications over the WAN 473, such as the Internet. The modem 472, which may be internal or external, may be connected to the system bus 421 via the user input interface 460 or other appropriate mechanism. A wireless networking component such as comprising an interface and antenna may be coupled through a suitable device such as an access point or peer computer to a WAN or LAN. In a networked environment, program modules depicted relative to the computer 410, or portions thereof, may be stored in the remote memory storage device. By way of example, and not limitation, FIG. 4 illustrates remote application programs 485 as residing on memory device 481. It may be appreciated that the network connections shown are exemplary and other means of establishing a communications link between the computers may be used.

An auxiliary subsystem 499 (e.g., for auxiliary display of content) may be connected via the user interface 460 to allow data such as program content, system status and event notifications to be provided to the user, even if the main portions of the computer system are in a low power state. The auxiliary subsystem 499 may be connected to the modem 472 and/or network interface 470 to allow communication between these systems while the main processing unit 420 is in a low power state.

### CONCLUSION

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. In a computing environment, a method performed on at least one processor comprising, receiving per-user profile data and current context information at a content provider, selecting content based upon the per-user profile data and the current context information or user interaction, or based upon the per-user profile data, the current context information and user interaction, and updating the per-user profile data based upon the current context information.

2. The method of claim 1 wherein the content provider comprises an advertising platform, and wherein selecting the content based upon the per-user profile data and current context information comprises selecting at least one advertisement.

3. The method of claim 2 further comprising, using bid-related information and bid-increment information with respect to an advertisement, including charging an advertiser differently when selecting the advertisement based upon the bid-increment information.

4. The method of claim 1 wherein receiving the per-user profile data and current context information comprises communicating with a search engine that is processing a query, the current context information including one or more keywords in the query, or one or more keywords related to the query, or both one or more keywords in the query and one or more keywords related to the query.

5. The method of claim 1 wherein the content provider comprises an advertising platform, wherein the content corresponds to a plurality of advertisements, and further comprising, ranking the advertisements relative to one another based upon the per-user profile data.

6. The method of claim 1 wherein the content provider comprises an advertising platform, wherein the content corresponds to a plurality of advertisements, and further comprising, suppressing at least one advertisement from appearing based upon the per-user profile data.

7. The method of claim 1 further comprising, modifying presentation of the content based upon the per-user profile data.

8. The method of claim 1 further comprising, sending the per-user profile data for maintaining only on a client device.

9. The method of claim 1 wherein updating the per-user profile data comprises determining whether adding one or more keywords to the per-user profile data increases utility or modifying one or more keywords in the per-user profile data increases utility, or both adding one or more keywords to the per-user profile data increases utility and modifying one or more keywords in the per-user profile data increases utility.

10. The method of claim 9 wherein the profile data comprise a plurality of profile components, and further comprising, using machine learning for estimating a predicted utility of each profile component.

11. The method of claim 9 wherein determining whether utility is increased comprises using one or more submodular optimization methods.

12. In a computing environment, a system comprising, an advertisement selection mechanism that receives context information and profile data representative of a user, and processes the context information and profile data to select advertisements; and
a profile update mechanism configured to update the profile data based upon the context information.

13. The system of claim 12 wherein the advertisement selection mechanism further selects advertisements based upon bid data of advertisers.

14. The system of claim 13 wherein the bid data comprises information by which an advertiser pays a different amount depending on the profile data.

15. The system of claim 12 wherein the profile data comprises a plurality of keywords, each keyword associated with time data, categorical data or match type data, or any combination of time data, categorical data or match type data.

16. The system of claim 12 wherein the profile data is maintained in a browser cookie.

17. The system of claim 12 wherein the profile update mechanism decides whether to update the profile data based upon utility computations, in which the utility computations include parameter values learned by machine learning.

18. One or more computer-readable media having computer-executable instructions, which when executed perform steps, comprising:
receiving per-user profile data and current context information at a advertising platform; and
selecting advertisements based upon advertiser bid data, the per-user profile data and current context information or user interaction, or based upon advertiser bid data, the per-user profile data and current context information and user interaction.

19. The one or more computer-readable media of claim 18 having further computer-executable instructions comprising, determining whether the current context information improves per-user profile data utility, and if so, updating the per-user profile data based upon the current context information

20. The one or more computer-readable media of claim 18 having further computer-executable instructions comprising, ranking the advertisements relative to one another based upon the per-user profile data, or changing presentation of at least one of the advertisements based upon the per-user profile data, or both ranking the advertisements relative to one another and changing the presentation of at least one of the advertisements based upon the per-user profile data.
